(19) United States
(12) Patent Application Publication
(10) Pub. No.: US 2016/0084586 A1
(43) Pub. Date: Mar. 24, 2016

(54) APPARATUS FOR PORTABLE STORAGE OF THERMAL ENERGY

(71) Applicant: DHAVAL VASANTKUMAR THAKKAR, Bangalore (IN)

(72) Inventor: Dhaval Vasantkumar THAKKAR, Bangalore (IN)

(21) Appl. No.: 14/889,717

(22) PCT Filed: May 7, 2014
(86) PCT No.: PCT/IN2014/000308

§ 371 Date: Nov. 6, 2015

(30) Foreign Application Priority Data
May 7, 2013 (IN) 2044/CHE/2013

(51) Int. Cl. F28D 20/00; B23P 15/26

(52) U.S. Cl. CPC F28D 20/003; B23P 15/26

(57) ABSTRACT

A device and apparatus for portable storage of thermal energy is disclosed. In an embodiment the device includes a core, one or more transfer interface and a core insulation. The core stores thermal energy. The one or more transfer interface communicates energy from an external source to the core and communicates energy stored in the core to an external recipient. The core insulation thermally insulates the core other than at the at least one transfer interface.

### BACKGROUND OF THE INVENTION

1. Field of the Invention

Embodiments of the present invention generally relate to enhancing usability of thermal energy, and more particularly to a system and method for capture, portable storage and utilization of thermal energy.

2. Description of the Related Art

Generally, thermal energy is abundantly available from various sources in multiple forms, such as renewable solar energy or from other sources as a by-product among others. Several techniques of capturing and using thermal energy are available at different scales. While, solar cookers and other solar powered appliances use solar energy at a smaller scale, solar energy power plants operate at a larger scale to provide electricity power through electricity grids. Further, several techniques for capturing and utilizing heat produced by automobile and industrial fuel combustion as a by-product also exist.

However, presently available techniques for capturing and utilizing thermal are generally restricted and cumbersome. Further, solar appliances have limited utility due to limitations of solar energy capturing techniques. Solar energy capturing techniques are functional only during limited time period and require extensive infrastructure. The setup for harnessing, for example, solar energy is usually stationary, requiring the point of energy capture and the point of use to be at the same location, which severely restricts the utilization of such energy.

Therefore, there is a need for an improved system and method for capture, storage and utilization of thermal energy.

### SUMMARY OF THE INVENTION

A device and apparatus for portable storage of thermal energy is disclosed. In an embodiment the device includes a core, one or more transfer interface and a core insulation. The core stores thermal energy. The one or more transfer interface communicates energy from an external source to the core and communicates energy stored in the core to an external recipient. The core insulation thermally insulates the core other than at the at least one transfer interface.

### BRIEF DESCRIPTION OF THE DRAWINGS

FIG. 1 depicts a thermal energy storage system, according to one or more embodiments;

FIG. 2 depicts a portable thermal energy storage device, according to one or more embodiments;

FIG. 3 depicts a portable thermal energy storage device with a thermochemical material core, according to one or more embodiments;

FIG. 4 depicts a transfer module of a portable thermal energy storage system, according to one or more embodiments;

FIG. 5 depicts a thermal energy utilizing device having a conducting interface, according to one or more embodiments; and

FIG. 6 depicts a thermal energy utilizing, device having a radiation interface, according to one or more embodiments.

While the portable thermal energy device and system is described herein by way of example for several embodiments and illustrative drawings, those skilled in the art will recognize that the portable thermal energy storage device and system is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the portable thermal energy storage device and system defined by the appended claims. The drawings and its components are not to scale and are illustrated as such for ease of depiction. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Various embodiments of a thermal energy capture, portable storage and utilization device and system are described. As such the system includes a portable thermal energy storage device, a transfer module and a thermal energy utilization device. The thermal storage device is portable and may store thermal energy, for example, by elevating the temperature of a substance or energy level of a chemical substance.

The transfer module captures energy from an energy source and transfers the captured thermal energy to the portable thermal energy storage device. Such acquisition of thermal energy by the thermal energy storage device is referred to herein, as charging.

The thermal energy utilization device dispenses heat acquired from a thermal energy source in a controllable manner. The thermal energy utilization device may use thermal energy stored in the portable thermal energy storage device as thermal energy source. Thermal energy egresses from the portable thermal energy storage device and is received by an energy recipient, for example the energy utilization device. Such egress of thermal energy from the portable thermal energy storage device is referred to herein, as discharging.

According to one embodiment the thermal energy storage device may store thermal energy by reducing the temperature of a substance to a temperature below ambient temperature, for example, below 0° Celsius. The thermal energy storage device may be charged to acquire temperature below 0° Celsius using a transfer module chilled using cooling agents for example, ice. According to an embodiment, the thermal energy utilization may dispense cold by interacting with such thermal energy storage device storing substance below 0° Celsius.

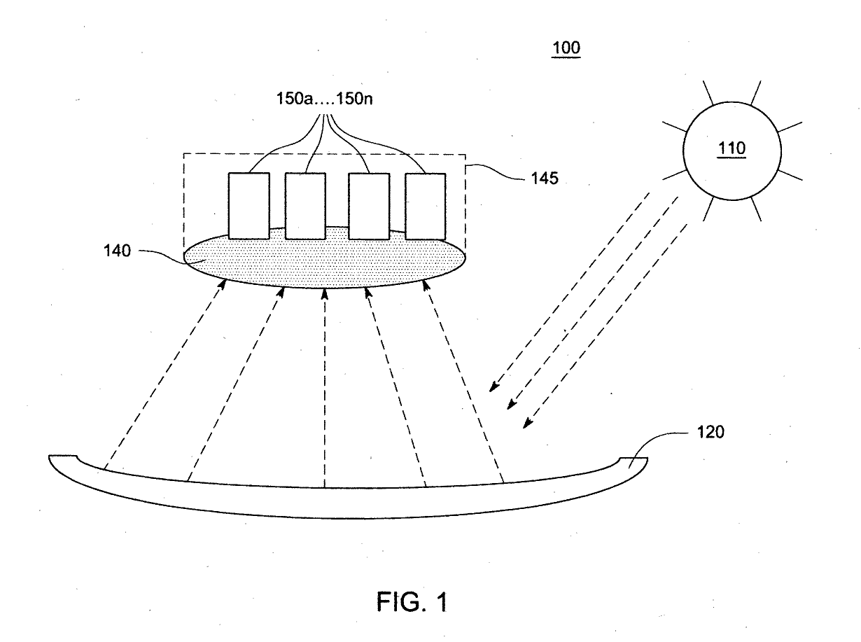

FIG. 1 depicts a thermal energy storage system 100. The thermal energy storage system 100 includes an energy source 110, a transfer module 140 and at least one thermal energy storage device 150. Energy from the energy source 110 is communicated to the at least one storage device 150 using the transfer module 140. As illustrated in FIG. 1, the thermal energy storage system 100 may include multiple storage devices 150a to 150n and the transfer module 140 transfers thermal energy to the multiple storage devices 150a to 150n.

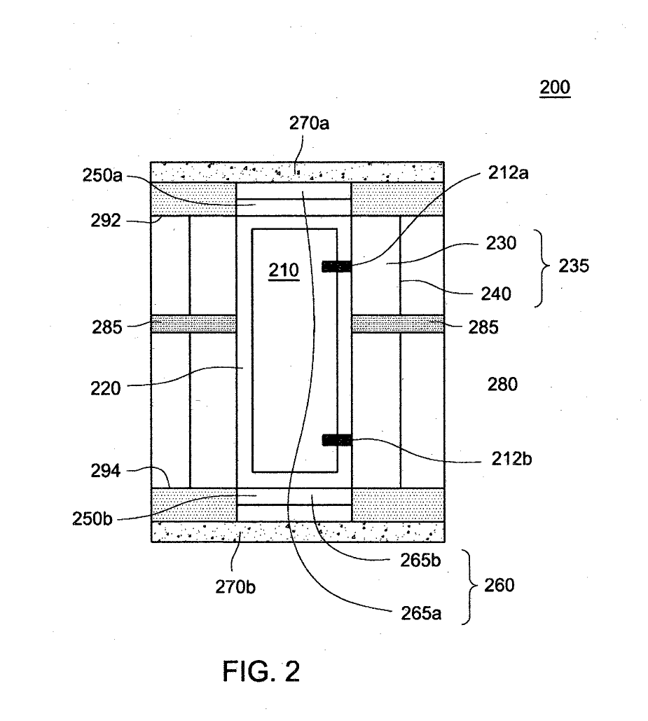

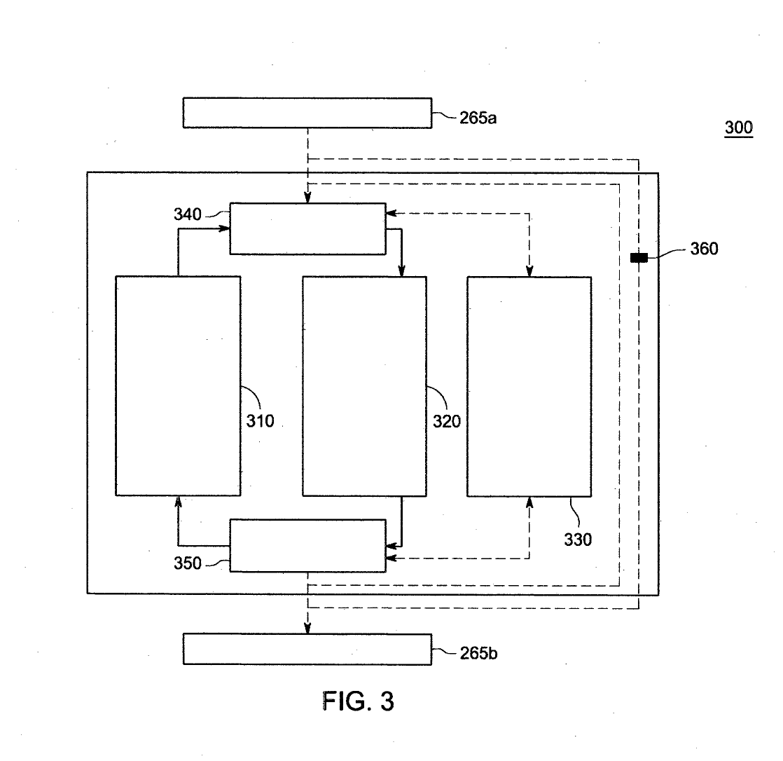

The at least one storage device 150 is a portable means of storing thermal energy, described in detail below, with respect to FIG. 2 and FIG. 3. The thermal energy stored in the at least one storage device 150 may be used by various thermal energy utilizing devices at any location, irrespective of both, location of the energy source 110 and the transfer module 140. According to some embodiments the one or more storage device 150 is designed for portability by humans. For example, the one or more storage device 150 may be designed to weigh below 10 kilograms making the one or more storage device 150 easy to be carried by humans manually without using a machine. Further, the one or more storage device 150 may include a handling contraption such as a handle at one or more places making the one or more storage device 150 easy to hold. After the thermal energy stored in the at least one storage device 150 has been used and the at least one storage device 150 is discharged completely or partially, the at least one storage device 150 may be charged again to repeatedly provide portable thermal energy.

The energy source 110 may provide energy in various forms. For example, the energy source 110 may provide energy in the form of heat or in the form electrical energy. Energy source 110 providing energy in the form of heat includes sources such as, solar energy, gas fire, wood-fire, industrial/automobile fuel combustion exhaust gas, heat exchanger and other waste heat among others.

According to an embodiment illustrated in FIG. 1, the thermal energy storage system 100 comprises a solar energy source and a concentrator 120. The concentrator 120 concentrates solar energy and directs concentrated energy to the transfer module 140. The concentrator 120 may be a parabolic dish, Fresnel reflector or other generally known concentrators known in the art. One skilled in the art will appreciate that, while the concentrator 120 is required to capture solar energy, capturing energy from other energy sources may not require the concentrator 120 and the transfer module 140 may obtain energy directly from the energy source 110. For example, the energy source 110 may be an electrical energy source and the transfer module 140 may include electrically conducting cables for transferring electrical energy to the at least one storage device 150.

According to some embodiments, the transfer module 140 and the at least one storage device 150 coupled to the transfer module 140 are covered by a system cover 145. The system cover 145 covers the at least one storage device 150 completely and the transfer platform 140 partially. The transfer platform 140 is covered by the system cover 145 except where the transfer platform 140 interacts to obtain energy from the energy source 110. The system cover 145 prevents loss of thermal energy from the transfer platform 140 due to rain water, blowing ambient air and other such cooling agents. Further, the system cover 145 prevents inadvertent accidents due contact of inexperienced operators, unsuspecting birds or the like with heated surfaces of the at least one storage device 150 or transfer platform 140.

FIG. 2 depicts the at least one storage device 150, according to an embodiment. The at least one storage device 150 comprises a core 210, one or more sensor 212a . . . n, at least one transfer interface 260, an outer shell 280, at least one thermally insulating heat cover 270, and structural components 290. The core 210 and the structural components 290 are contained in the outer shell 280. The outer shell may be fabricated using suitable materials such as materials that provide appropriate rigidity along with ease to be handled by humans. The structural components 290, support and hold the core 210 and the at least one transfer interface 260 in position. The core 210 may store thermal energy, by elevating temperature of a material (for example, graphite), or by transforming a chemical substance from a low energy state to a high energy state. The one or more sensor 212a . . . n is configured to detect available energy content of the core 210. The one or more sensor 212a . . . n may for example, obtain temperature of the core 210.

According to some embodiments, the at least one temperature or available energy content sensor 212a . . . n comprises any device that senses temperature such as a thermocouple, thermostat, and a thermistor among others.

According to one embodiment, the core 210 comprises phase change materials (PCM) that store thermal energy by changing phase. For example, water may comprise the core 210 and store energy by changing into high temperature water, water vapor or low temperature water ice.

While charging the at least one storage device 150, the at least one transfer interface 260 communicates with the transfer module 140, to communicate energy to the core 210. While discharging, the at least one transfer interface 260 communicates thermal energy stored in the core 210 to a thermal energy utilizing device. One skilled in the art will appreciate that the at least one transfer interface 260 may allow thermal communication to and from the core 210 by various modes of thermal communication including conduction, convection, absorption and radiation or a combination thereof. The transfer module 140 and the at least one transfer interface 260 are suitably adapted for thermal communication by various modes of thermal communication using techniques generally known in the art. The at least one heat cover 270 insulates the at least one transfer interface 260, when the at least one transfer interface 260 is not coupled to either the transfer module 140 or the thermal energy utilizing device. The at least one heat cover 270 is removed to allow the at least one transfer interface 260 to thermally communicate, with the transfer module 140 while charging, and with the thermal energy utilizing device while discharging.

Those skilled in the art will appreciate that number and placement of the at least one temperature sensor 212a . . . n depends on desired control of temperature or thermal energy state of the core 210 while charging and discharging. For example, as depicted in FIG. 2, the at least one temperature sensor 212a . . . n comprises a first temperature sensor 212a and a second temperature sensor 212b. The first temperature sensor 212a is placed proximal to the ingress interface 265a and the second temperature sensor 212b is placed distal to the ingress interface 265b. Such placement of two temperature sensors provides for monitoring temperature elevation of the core 210 proximal to the point of heat ingress and distal to the point of heat ingress while charging, and temperature reduction of the core 210 proximal to the point of heat egress and distal to the point of heat egress while discharging. An approximate change in thermal energy of the core 210 while charging or discharging may be monitored by placing a single temperature sensor 212 at a midpoint of the core 210. Similarly, a single temperature sensor 212 or multiple temperature sensors 212a . . . n may be provided in the at least one storage device 150 with a single transfer interface 260 and may be placed distal or proximal to the transfer interface 260. Multiple temperature sensors across the core 210 provide a temperature gradient that may be established across the core 210 from proximal to the transfer interface 260 to distal from the transfer interface 260.

According to one embodiment, the at least one storage device 150 uses same mode of thermal communication while charging and discharging and comprises one transfer interface 260. The at least one transfer interface 260 may be interchangeably used for charging and discharging the at least one storage device 150, when the at least one storage device 150 uses same mode of thermal communication while charging and discharging.

According to another embodiment, the at least one storage device 150 uses different modes of thermal communication while charging and discharging and the at least one transfer interface 260 comprises an ingress interface 265a and an egress interface 265b. The ingress interface 265a and the egress interface 265b use different modes of thermal communication and are therefore not interchangeably used for charging and discharging the at least one storage device 150. Further, the at least one storage device 150 using different modes of charging and discharging comprises the at least one heat cover 270 comprising a first removable heat cover 270a and a second removable heat cover 270b. The first heat removable cover 270a insulates the ingress interface 265a and the second removable heat cover 270b insulates the egress interface 265b.

According to an embodiment, the structural components 290 include a top support 292, a middle support 285, a bottom support 294, a first gasket 250a, a second gasket 250b and an inner covering layer 220. The top support 292, the middle support 285 and the bottom support 294 support the core 210 in the at least one thermal storage device 150. The inner covering layer 220 surrounds and protects the core 210 while allowing the at least one transfer interface 260 to thermally communicate with the core 210. The first gasket 250a holds the ingress interface 265a in thermal communication with the core 210 and the second gasket 250b holds the egress interface 265b in thermal communication with the core 210. One skilled in the art will appreciate that while two gaskets, the first gasket 250a and the second gasket 250b are required for the at least one storage device 150 comprising separate ingress and egress interface, a single gasket may suffice for the at least one storage device 150 comprising one transfer interface and using the same mode of thermal Communication for charging and discharging. Those skilled in the art will appreciate that functionalities described herein may be achieved by alternative configurations without departing from scope and spirit of the present invention.

According to an embodiment, the core 210 may include a resistor. Accordingly, the at least one storage device 150 comprising the resistor is charged by conduction of electrical energy through the ingress interface 265a and discharged by communication of thermal energy through the egress interface 265b.

According to an embodiment illustrated in FIG. 2, the at least one storage device 150 comprises the core 210 that stores thermal energy in the form of a material having elevated temperature and a core insulation 235. The core insulation 235 insulates the core 210 other than at the transfer interface. The core insulation 235 may comprise an insulation 230 and a reflector 240. One skilled in the art will appreciate that while the core insulation 235 thermally insulates the core 210 that stores thermal energy in the form of a material having elevated temperature, the core insulator 235 may further chemically insulate the core 210 that stores thermal energy by transforming a chemical substance from a low energy state to a high energy. While a specific configuration of physical structure is illustrated by FIG. 2, such physical structure is depicted for providing structural support, thermal insulation and other functions as illustrated herein. Those skilled in the art will appreciate that functionalities described herein may be achieved by alternative configurations without departing from scope and spirit of the present invention.

According to an embodiment, the portable thermal energy storage system 100 comprises the at least one storage device 150 including a thermochemical material core (TCM core) 370. FIG. 3 depicts the TCM core 370 that stores thermal energy by transforming a chemical substance from a low energy state to a high energy. The chemical substance comprising the TCM core 370 may be any of the thermochemical substances generally known in the art such as, for example, magnesium sulphate heptahydrate (MgSO4.7H2O), magnesium chloride hexahydrate (MgCl2.6H2O), and calcium chloride dihydrate (CaCl2.2H2O), among others. The TCM core 370 comprises a first container 310 containing a chemical substance in low energy state, a second container 320 containing the chemical substance in high energy state, at least one dissociated entity container 330, an endothermic reactor 340 and an exothermic reactor 350.

The chemical substance stored in low energy state in the first container 310 translates to the endothermic reactor 340. While charging, the ingress interface 265a communicates heat to the endothermic reactor 340, and the chemical substance is transformed to a high energy state. Thereby, thermal energy is stored in the form of the chemical substance in high energy state stored in the second container 320. While discharging, the chemical substance in high energy state reacts in the exothermic reactor 350 to release heat that is communicated to the egress interface 265b. According to an embodiment, the chemical substance in high energy state may dissociate into the chemical substance in low energy state and at least one chemical entity, in the exothermic reactor 350, to release energy while discharging. Alternatively, the chemical substance in high energy state may associate with at least one chemical entity, in the exothermic reactor 350, to form the chemical substance in low energy state and release energy while discharging. The at least one chemical entity is stored temporarily in the at least one dissociated entity container 330 to be provided to the endothermic reactor 340 or the exothermic reactor 350 for association according to the thermochemical used in the TCM core 370. For example, TCM used may be magnesium sulphate heptahydrate. While charging, reaction in the endothermic reactor 340 provides the chemical substance in high energy state (magnesium sulphate) and the at least one chemical entity (vapor). Vapor is stored in the at least one dissociated entity container 330. During discharge, vapor is provided to the exothermic reactor 350 to associate with magnesium sulphate. Alternatively, while charging, reaction in the endothermic reactor 340, may provide a chemical substance in high energy state by associating with the at least one chemical entity. Such chemical substance in high energy state may dissociate in the exothermic reactor 350 to give out heat, the chemical substance in low energy state and the at least one chemical entity, while discharging.

As described above, the TCM core 370 depicted in FIG. 3 is one embodiment of the core 210 depicted in FIG. 2. Those skilled in the art will appreciate that while the core 210 is depicted in FIG. 2 and described to be thermally insulated with core insulation 235, according to one embodiment, the TCM core 310 may not be thermally insulated with core insulation 235. According to one embodiment, only the endothermic reactor 340 and the exothermic reactor 350 are thermally insulated other than at the ingress interface 265a and the egress interface 265b respectively. Accordingly, the first container 310, the second container 320 and the one or more dissociated entity container 330 may not be thermally insulated.

According to some embodiments the TCM core 370 may further comprise an energy indicator 360. The energy indicator 360 is communicably coupled to the endothermic reactor 340 and the exothermic reactor 350 to record amount of thermal energy received by the endothermic reactor 340 or amount of heat produced by the exothermic reactor 350 respectively. Depending on the measurements made at the endothermic reactor 340 and the exothermic reactor 350, the energy indicator 360 may be configured to indicate amount of energy available in the at least one storage device 150. According to an embodiment, the energy indicator 360 may be coupled to the second container 320 and the first container 310 and configured, by techniques generally known in the art, to compute energy available in the at least one storage device 150 according to the absolute or relative amounts of material contained in the containers.

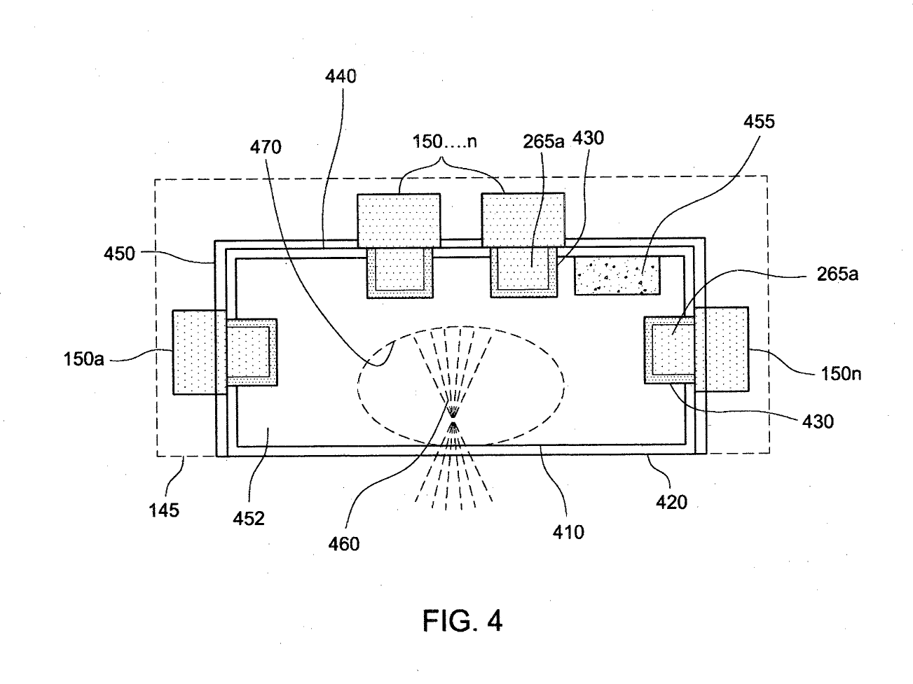

FIG. 4, depicts the transfer module 140 of the thermal energy storage system 100 of FIG. 1, according to an embodiment of the invention. The transfer module 140 includes a first surface 450, a second surface 470 and a transfer medium 452. The first surface 450 has a transfer port 430 for coupling with and transferring thermal energy to the storage device 150. The second surface 470 defines an energy capturing enclosure 460. The energy capturing enclosure 460 is adapted to maximize capture of energy incident on the second surface 470. The transfer medium 452 may be fabricated using various materials including carbon, silicon, and a combination thereof.

According to an embodiment, the second surface 470 includes an energy incidence zone 410. The energy incidence zone 410 receives energy from an energy source external to the energy capturing enclosure 460 and allows the energy received to enter the energy capturing enclosure 460. Energy entering the energy capturing enclosure 460 is at least one of absorbed, reflected or radiated by the second surface 470. The second surface 470 is configured to reflect, radiate and absorb substantial part of the energy entering the energy capturing enclosure 460. The second surface 470 defines the energy capturing enclosure 460. Shape and form of the energy capturing enclosure 460 so defined by the second surface 470 ensures energy entering the energy capturing enclosure 460 and reflected by the second surface 470 is substantially reflected within the energy capturing enclosure 460. The energy incidence zone 410 is covered by an incidence zone cover 420. The incidence zone cover 420 reduces heat loss due to ambient cooling agents (e.g.: rain water, blowing air) and damage to living beings due to inadvertent contact with heated surface of the energy incidence zone 410. The incident zone cover 420 may comprise materials tolerant to high temperatures generally known in the art, for example, glass ceramic or vacuum insulated glass.

The first surface 450 includes one or more transfer port 430 for coupling With the one or more thermal storage device 150. The one or more transfer ports 430 include suitable material that transfers heat efficiently from the transfer module 140 to the one or more thermal storage device 150, such as composite materials (e.g.: a metal alloy). The one or more charging port 430 is configured to couple and communicate thermal energy to the at least one transfer interface 260 or 340 of the at least one storage device 150.

A transfer module insulation 440 thermally insulates the transfer module 140 other than at the energy incidence zone 410 and the one or, more charging port 430. Those skilled in the art will appreciate that thermal insulations are generally fragile. Accordingly, the transfer module insulation 440 may be strengthened by addition of a suitable rigid material. Each of the one or more charging ports 430 covered by a thermally insulating removable port cover (not shown in FIG. 4a for simplicity of representation) when the at least one storage device 150 is not coupled to the one or more charging ports 430.

According to some embodiments, a heat exchanger 455 may be removably disposed on the transfer module 140 or permanently disposed on the transfer module 140. The heat exchanger 455 is configured to absorb excess heat from the transfer module 140. The heat exchanger 455 may be triggered into action to absorb heat from the transfer module 140 when temperature of the transfer module exceeds a predetermined temperature limit. Such heat absorbed may be utilized as heat source for various heat requiring applications known in the art, such as air conditioning, refrigeration, thermal storage for later use or indirect electrification applications through vapor cycle. Further, the heat exchanger 455 may be configured to interact with the transfer module 140 at the one or more transfer ports 430 or via other thermally communicating coupling means, generally known in the art. According to an embodiment, a thermoelectric device, (not shown in FIG. 4a for simplicity of representation) may be coupled to the transfer module 140 to absorb the excess heat and convert to the excess heat to electricity to be stored or used by techniques generally known in the art.

Further, the second surface 470 is configured to maximize capture of energy entering the energy capturing enclosure 460. According to an embodiment, the energy capturing enclosure 460 includes two symmetrical halves. Furthermore, the second surface 470 may curve inwards at periphery of the energy incidence zone 410. Profile of the second surface 470 is configured to reflect energy radiations entering the energy capturing enclosure 460 within the energy capturing enclosure 460 multiple times. Multiple reflections of the energy radiations within the energy capturing enclosure 460 maximize total energy captured by the energy capturing enclosure 460. Also, the two symmetrical halves allow capture of energy radiations entering the energy capturing enclosure 460 from both left and right side of the energy incidence zone 410.

As explained earlier in detail with reference to FIG. 1, the transfer module 140 captures energy radiations that are directed from the concentrator 120 to the transfer module 140. For effective capture of energy, the transfer module 140 is placed such that the second surface 470 is placed after the focal point or focal lane plane of the concentrator 120. According to an embodiment illustrated in FIG. 4b, the focal point or focal plane may lie just above the energy incidence zone 410. Accordingly, the energy incidence zone 410 may be extended at least partially to receive concentrated energy at a focal plane of a concentrator 120 that is for example, a linear mirrored parabolic dish or a linear parabolic trough.

According to an embodiment, from the energy source 110 may be combustion of a combustible substance. The combustible substance may be combusted in proximity of the energy incidence zone 410, such that heat radiations are incident on the energy incidence zone 410. Alternatively, the combustible substance may be combusted within the energy capturing enclosure 460. Accordingly, the energy incidence zone 410 allows exit of exhaust of the burning combustible substance from the energy capturing enclosure 460. Alternatively, the energy capturing enclosure 460 further includes an exhaust opening (not shown in FIG. 4a for simplicity of representation) to allow exit of exhaust of the burning combustible substance from the energy capturing enclosure 460. Those skilled in the art will appreciate that the second surface 470 of the energy capturing enclosure 460 is constructed using materials that are tolerant to such combustion while allowing communication of thermal energy to the transfer medium 452.

According to some embodiments a communication system (not shown in FIG. 4 for simplicity of representation) for indication that the at least one storage device 150 has acquired a predetermined energy content (e.g. temperature attained on uptake of maximum possible heat) is also provided. Such communication system is couples the at least one sensor 212a . . . n and a controller (not shown) is configured to control thermal energy transferred to the at least one core. The one or more sensor, the communication system and the controller together as such function to ensure that energy being provided to the at least one storage device 150 is stopped, once the at least one storage device 150 is desirably charged. Those skilled in the art will appreciate that such communication system and controller may either be disposed on the at least one storage device 150, or partially on the at least one storage device 150 and partially on the transfer module 140 according to the desired design of the communication system. According to one embodiment, the communication system may be disposed on the at least one storage device 150 and may indicate that the at least one storage device 150 is fully charged by visual signal (for example, an lighting on of an LED and a digital text message received on a computing device) or audio signal (for example, an alarm) according to temperature recorded on the at least one temperature sensor 212a . . . n. Visual or audio signals may be used by an operator to learn that the at least one storage device 150 is desirably charged and the operator may either replace the desirably charged at least one storage device 150 with one that requires charging or decouple the desirably charged at least one storage device 150 from the one or more transfer ports 430 to prevent overcharging of the at least one storage device 150. According to another embodiment, the communication system may be disposed partially on the at least one storage device 150 and partially on the transfer module 140 and may automatically trigger an alert control mechanism on the controller that stops transfer of thermal energy from the transfer module 140 to the at least one storage device 150. Alternatively, the communication system may actuate the heat exchanger 455 or the thermoelectric device to absorb thermal energy from the transfer module 140.

According to an embodiment, the transfer module 140 comprises a temperature sensor (not shown in FIG. 4). The temperature sensor senses the temperature attained by the transfer medium 452. Further, the temperature sensor is in communication with a temperature control device. The temperature control device is configured to control energy received by the transfer module 140. The temperature control device may disposed on the transfer module 140 and connected to the temperature sensor by cables for communication or located at a remote site and in communication with the temperature sensor by wireless means generally known in the art. The temperature control device may, for example, actuate cessation of reception of energy by the transfer module on receiving communication of the transfer medium 452 attaining a pre-determined temperature. Accordingly, the temperature control device may stop energy being received from an energy source external or internal to the transfer module 140.

According to the portable thermal energy storage system 100 illustrated in FIG. 1 and the transfer module 140 illustrated in FIG. 4, multiple storage devices 150a . . . n are coupled to the transfer module 140. Each of the multiple storage devices 150a . . . n coupled to the transfer module 140 having multiple transfer ports 430 is described here only as an example. The portable thermal energy system 100 may comprise a single storage device 150.

According to one embodiment, the portable thermal energy storage system 100 comprises a single storage device 150 and may use one of the multiple transfer ports 430 of the transfer module 140 for charging. Alternatively, the transfer module 140 may comprise a single transfer port 430 and the single storage device may be permanently coupled to the transfer module 140. For example, the at least one storage device 150 comprising a graphite core 210 may be permanently coupled to the transfer module 140 fabricated using graphite. Further, according to an embodiment, the core 210, the ingress interface 265a and the single transfer port are fabricated using graphite. Accordingly, the graphite core 210, the graphite ingress interface 265a, the graphite single transfer port 430 and the graphite transfer medium 452 may form a continuous graphite structure coupling with an electrical energy source.

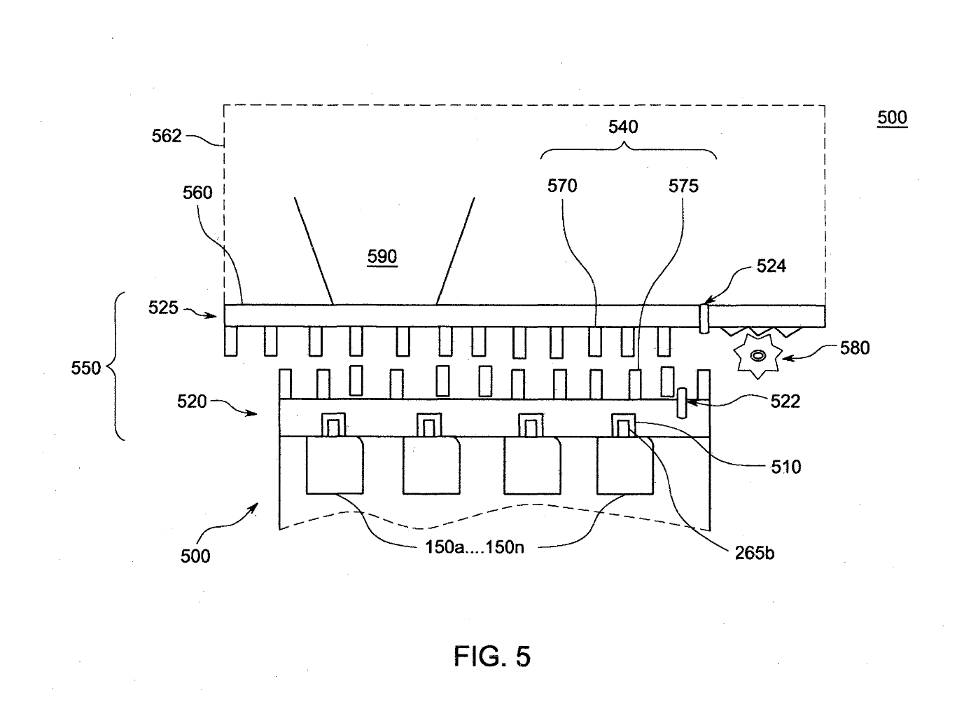

FIG. 5 depicts a thermal energy utilizing device 500 having a conducting interface, according to an embodiment of the invention. The heat utilizing device 500 comprises a controllable heat dispensing device 550 and at least one thermal energy storage device 150. The controllable heat dispensing device 550 further comprises a heat communicating module 520, a heat dispensing module 550, a thermal interaction layer 540 and a heat control device 580. The thermal interaction layer is interposed between the heat dispensing module 550 and the heat communicating module 520 and communicated heat from the heat communicating module 520 to the heat dispensing module 550. The heat communicating module 520 comprises a utilization port 510. The utilization port 510 couples and thermally communicates with the at least one transfer interface 265 or the at least one egress interface 265b of the one or more storage devices 150a . . . n. The heat dispensing module 550 comprises a heat dispensing surface 560 that controllably dispenses heat.

According to an embodiment illustrated in FIG. 5, the controllable heat dispensing device 550 is a cooking hot plate and the heat dispensing surface 560 supports an object to be heated, for example, a cooking vessel 590. The cooking vessel 590 contains edible substance that is heated using the heat stored in the one or more storage devices 150a . . . n. Further, as shown in FIG. 5, the heat dispensing surface 560 may be covered with a thermally insulating cover 562 to prevent heat loss to the ambience. The controllable heat dispensing device 550 is illustrated here as a cooking hot plate merely as an example and not as a limitation of the controllable heat dispensing device 550. One skilled in the art will appreciate that the controllable heat dispensing device 550 may be an ambience heating device, for example, a boiler, a room heater, a car heater, a cooking oven, a refrigeration, an air conditioner or a device that converts heat into electricity.

The heat dispensing surface may be disposed in an enclosure. The enclosure may comprise substance such as fluids to be heated, for example, water in a boiler. Further, the controllable heat dispensing device 550 may comprise a part of other heat requiring devices such as industrial fermenters among others.

Heat is communicated to the heat dispensing surface 560 of the heat dispensing module 550 from the one or more storage devices 150a . . . n coupled directly or indirectly to the utilization port 510 of the heat communicating module 520 through the thermal interaction layer 540. Heat may be communicated by conduction means, convection means or radiation means. The heat control device 580 controls heat communicated to the heat dispensing surface 525. According to one embodiment, the heat control device 580 may comprise a rack and pinion assembly that actuates horizontal translation of the heat dispensing module 625 with respect to the heat communicating module 520. The heat control device 580 may, for example, be disposed on the heat dispensing module 525 or on the heat communicating module 520 to allow minimal encumbrances on optimal usage of the heat dispensing surface 560. The heat control device 580 as a rack and pinion assembly that actuates horizontal translation of the heat dispensing module 525 is, described here only as an exemplary embodiment. Other techniques generally known in the art may be employed to alter heat communicated to the heat dispensing surface 525.

According to some embodiments, the thermal energy utilizing device 500 may further comprise an automated temperature regulating system comprising a computing circuit, a first thermostat 522 and a second thermostat 524. (computing circuit not shown in the figure for simplicity of representation). The thermostats 522 and 524 and the computing circuit are suitably coupled to automatically control temperature of the heat dispensing surface 560 by controlling heat being provided to the heat dispensing surface 560. For example, the first thermostat 522 may be coupled to monitor temperature of the heat communicating module 520 and the second thermostat 524 may be coupled to monitor temperature of the heat dispensing surface 560. Depending on temperature requirement at the heat dispensing surface 560, status of the second thermostat 524, and status of the first thermostat 522, the computing circuit may actuate the heat control device 580 to alter heat being communicated to the heat dispensing surface 560.

According to an embodiment illustrated in FIG. 5, the thermal interaction layer 540 is a conducting interface and employs conduction as means of thermal communication. The interaction layer 540 comprises a first element 575 disposed on the heat communicating module 520 and a second element 570 disposed on the heat dispensing module 525. The first element 575 and the second element 570 are depicted in FIG. 5 as discrete projections only as an exemplary embodiment. The discrete projections, for example, may be provided with a 4:5 ratio of projected surface to gap in order to provide for allowing zero interaction arrangement. In other embodiments, different structures such as, a continuous surface, uneven, equal gapping, spiral incremental conductive surface may be used for heat transfer. The first element 575 and the second element 570 make contact to comprise the conducting interface and conduct heat to the heat dispensing surface 525.

The heat control device 580 may for example, control heat communicated to the heat dispensing surface 560 by varying area of the conducting interface. For example, horizontal or vertical translation of the heat dispensing module 525 with respect to the heat communicating module 520 may be used to vary the area of the conducting interface by varying number of discrete projections of the first element 570 and the second element 575 that are in physical contact.

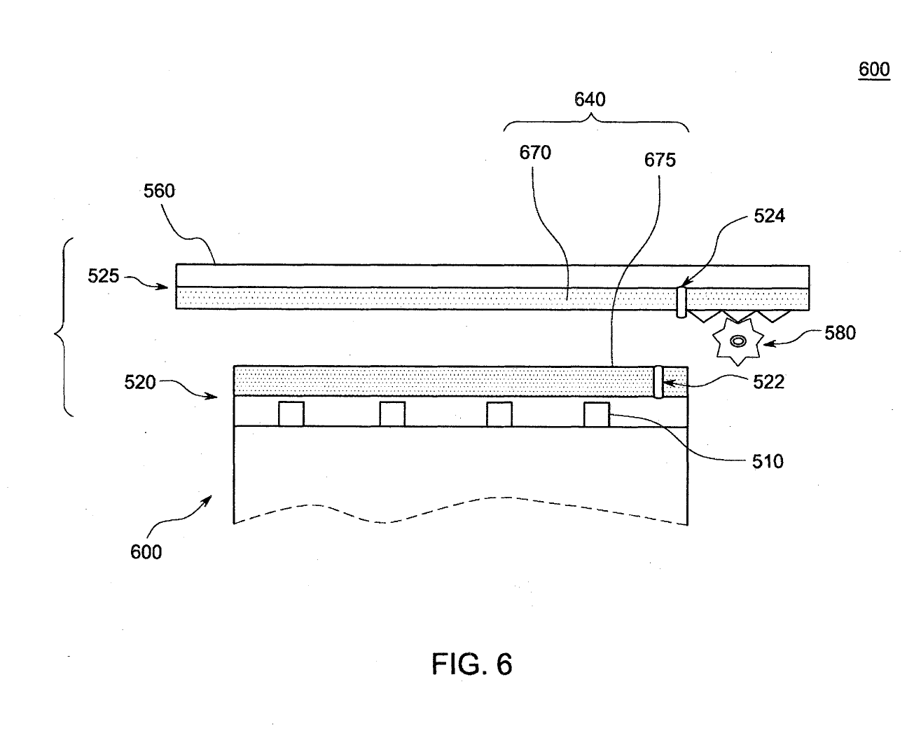

FIG. 6 depicts a controllable thermal energy dispensing device 600 having a radiation based thermal interaction layer 640. According to an embodiment illustrated in FIG. 6, the thermal interaction layer 640 is a radiation interface. The thermal interaction layer 640 comprises an emitting surface 675 disposed on the heat communicating module 520 and an absorbing surface 670 disposed on the heat dispensing module 525. The emitting surface 675 and the absorbing surface 670 comprise materials that are generally known in the art to provide high emissivity and absorption respectively. The emitting surface 675 radiates heat obtained from the at least one storage devices 150a . . . n. The absorbing surface 670 is disposed with respect to the emitting surface 675 for substantially absorbing radiations emitted by the emitting surface 675 to comprise the radiation interface. The absorbing surface 670 conducts such heat absorbed to the dispensing surface 525. Further, the heat control device 580 may for example, control heat communicated to the heat dispensing surface 560 by varying area of the radiation interface. For example, horizontal or vertical translation of the heat dispensing module 525 with respect to the heat communicating module 520 varies the area of radiation interface 640 between the emitting surface 675 and the absorbing surface 670.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The present invention offers various advantages by providing portability and flexibility to capture and utilization of thermal energy storage. The portable thermal energy storage device expands applicability of thermal energy captured from renewable and other energy sources. The portable thermal energy device can be transported and used at a time and place different from a place and time at which the storage device is charged. Further, the portable thermal energy storage device allows scalability in utilization of thermal energy. A thermal energy utilization device using the portable thermal energy may use variable number of such storage devices to derive various scales of heat capability.

While the foregoing is directed to embodiments of the present invention, other and further embodiments of the invention may be devised without departing from the basic scope thereof, and the scope thereof is determined by the claims that follow.

1. A device comprising:
a core for storing thermal energy;
at least one transfer interface for communicating energy from an external source to the core, and for communicating energy stored in the core to an external energy recipient; and
a core insulation thermally insulating the core other than at the at least one transfer interface.

2. The device of claim 1, wherein the at least one transfer interface communicates at least one of electrical energy and thermal energy to the core.

3. The device of claim 1, wherein the at least one core comprises a resistor.

4. The device of claim 1 further comprising a sensor for indicating available energy content of the core.

5. The device of claim 4, wherein the sensor communicates the energy content of the core to a controller configured to control transfer of energy to the at least one core.

6. The device of claim 1, wherein the external source is at a location different than the external energy recipient.

7. The device of claim 6, wherein the device is manually portable between the location of the external source and location of the external recipient.

8. The device of claim 1, wherein the transfer interface further comprises:
a thermal energy ingress interface that communicates thermal energy to the core; and
a thermal energy egress interface that communicates thermal energy from the core to the energy recipient.

9. The device of claim 8, wherein the core stores thermal energy by transforming a chemical substance from a low energy state to a high energy state.

10. The device of claim 1, wherein the at least one transfer interface is covered by a heat cover for thermally insulating the at least one transfer interface when the at least one transfer interface is not communicating energy from an external source to the core and from the core to an external energy recipient.

11. A device comprising:
an endothermic reactor in fluid communication with a first container and in thermal communication with an ingress interface, the first container containing the chemical substance in low energy state and the ingress interface transferring thermal energy from an external energy source to the endothermic reactor;
an exothermic reactor in fluid communication with a second container and in thermal communication with an egress interface, the second container containing the chemical substance in high energy state and the egress interface transferring thermal energy from the exothermic reactor to an external energy recipient, wherein the endothermic reactor is thermally insulated other than at the ingress interface and the exothermic reactor is thermally insulated other than at the egress interface and
the chemical substance transforms to the high energy state using thermal energy obtained from the ingress interface and the chemical substance transforms to the low energy state when thermal energy egresses from the exothermic reactor via the egress interface.

12. An apparatus comprising:
an energy source; and
a device, the device further comprising:
a core for storing thermal energy;
at least one transfer interface for communicating energy from the energy source to the core, and for communicating energy stored in the core to an external energy recipient; and
a core insulation for thermally insulating the core other than at the at least one transfer interface, wherein the energy source is external to the device.

13. The apparatus of claim 12 further comprising a transfer module thermally coupled to the energy source and the device, wherein the transfer module captures energy from the energy source and transfers thermal energy to the at least one portable thermal energy device.

14. The apparatus of claim 12, wherein the energy source comprises at least one of thermal energy, electrical energy and solar energy.

15. The apparatus of claim 12, wherein the communication of energy from the energy source to the core occurs at a location different than the communication of energy from the core to the external recipient.

16. The apparatus of claim 12 further comprising a sensor for indicating available energy content of the core.

17. The apparatus of claim 12, wherein the at least one transfer interface further comprises:
a thermal energy ingress interface that communicates thermal energy to the core; and
a thermal energy egress interface that communicates thermal energy from the core to a heat utilizing system.

18. The apparatus of claim 17, wherein the core stores thermal energy by transforming a chemical substance from a low energy state to a high energy state.

19. A method of manufacturing a device, the method comprising:
providing a core for storing thermal energy;
providing at least one transfer interface for communicating energy from an external source to the core, and for communicating energy stored in the core to an external energy recipient; and
providing a core insulation thermally insulating the core other than at the at least one interface.
